(19) United States
(12) Patent Application Publication
(10) Pub. No.: US 2010/0303368 A1
(43) Pub. Date: Dec. 2, 2010

(54) IMAGE DISPLAY METHOD, IMAGE MATCHING METHOD, AND DISPLAY APPARATUS USING THE SAME

(75) Inventors: In-ra JANG, Gwangmyeong-si (KR); Hong-seok Yang, Seongnam-si (KR); Ji-hyun Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/628,262

(22) Filed: Dec. 1, 2009

(30) Foreign Application Priority Data
May 28, 2009 (KR) 2009-46762

(51) Int. Cl. G06K 9/36

(52) U.S. Cl. 382/233

(57) ABSTRACT

An image display method, an image matching method, and a display apparatus using the same. An image display method includes determining a representative property of an image, and displaying the image together with representative property information. Accordingly, images are displayed in a row so that a user does not need to wait while an image is being decoded, and information regarding a property of the image to be displayed is previously provided the user, so the user can effectively watch the image.

### CROSS-REFERENCE TO RELATED APPLICATIONS

This application claims the benefit of priority under 35 U.S.C. §119 (a) from Korean Patent Application No. 10-2009-0046762, filed on May 28, 2009, in the Korean Intellectual Property Office, the disclosure of which is incorporated herein by reference in its entirety . . . .

### BACKGROUND

1. Field of the Invention

The present general inventive concept relates to an image display method, an image matching method, and a display apparatus using the same. More particularly, the present general inventive concept relates to an image display method to provide images in a row, an image matching method, and a display apparatus using the same.

2. Description of the Related Art

As image capture apparatuses such as digital cameras and camcorders are becoming more widespread, and mobile communication terminals mounting an image capture apparatus are becoming more generalized, it becomes easy to capture images.

An image capture apparatus compresses and stores a captured image, and decodes the image so as to display the image on screen. Since the compressed image has to be decoded, the image capture apparatus cannot immediately display the image on screen when receiving a command to output the image. Accordingly, a user cannot view images in a row.

In addition, if an image is displayed, subsidiary information regarding the image is displayed together around the image.

Therefore, there is a need for methods for the user not to have to wait while a compressed image is decoded and to smoothly watch images without interference by subsidiary information by previously providing the user with prior information regarding the image to be decoded in the form of an image.

### SUMMARY

The foregoing and/or other features and utilities of the present general inventive concept may be achieved by providing an image display method to provide images in a row and previously provide information regarding a property of an image, an image matching method, and a display apparatus using the same.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image display method, the method including determining a representative property from among at least one property of an image, and displaying the image together with representative property information, which is information regarding the representative property, if a command to display the image is input.

The displaying of the image may include decoding the image if the command to display the image is input, in a first display operation, displaying the representative property information before the image is decoded and can be displayed, and in a second display operation, displaying the image.

The second display operation may include stopping displaying the representative property information and displaying the image if it is determined that the image is decoded and can be displayed.

The first display operation may include displaying information regarding another property from among the at least one property of the image if the representative property information is completely displayed before the image is decoded and can be displayed.

The displaying of the image may include automatically displaying the image even though a separate command is not input after displaying the representative property information.

If the representative property is a capture date, the representative property information may be image information indicating that time moves from today to the capture date.

If the representative property is event information regarding an anniversary, the representative property information may be image information indicating the anniversary.

The foregoing and/or other features and utilities of the present general inventive concept may be achieved by providing an image matching method, the method including determining a representative property from among at least one property of a captured image, and matching representative property information, which is information regarding the representative property, with the captured image.

The image matching method may further include displaying the captured image together with the representative property information if a command to display the captured image is input.

The displaying of the captured image may include alternately displaying each representative property information and each image if a command to display a plurality of images is input.

The property may include at least one of event information, tag information, name information, capture date information of the captured image, and the representative property may be a property which is designated as the highest distinction between the captured image and other images from among the at least one property.

The representative property information may be an image which is designated as the biggest expression of the representative property from among stored images.

The representative property information may be designated by a user or may be automatically designated from among the stored images according to preset priority.

The foregoing and/or other features and utilities of the present general inventive concept may also be achieved by providing a display apparatus including a display unit to display an image, and a control unit to determine a representative property from among at least one property of the image, and display the image together with representative property information, which is information regarding the representative property, if a command to display the image is input.

The display apparatus may further include a decoding unit to decode the image, wherein the control unit displays the representative property information before the image is decoded and can be displayed, and subsequently displays the image.

The control unit may automatically display the image even though a separate command is not input after the representative property information is displayed.

The control unit may alternately display each representative property information and each image if a command to display a plurality of images is input.

The property may include at least one of event information, tag information, name information, capture date information of the image, and the representative property may be a property which is designated as the highest distinction between the image and other images from among the at least one property.

The representative property information may be an image which is designated as the biggest expression of the representative property from among stored images.

The representative property information may be designated by a user or may be automatically designated from among the stored images according to preset priority.

The foregoing and/or other features and utilities of the present general inventive concept may also be achieved by providing a method of displaying an image, including extracting from a storage a representative property based on at least one property which is preset for an image to be displayed on a display unit, and displaying information regarding the representative property and then the image to be displayed.

The foregoing and/or other features and utilities of the present general inventive concept may also be achieved by providing a computer-readable medium containing codes to perform a method of image display, the method including determining a representative property from among at least one property of an image, and displaying the image together with representative property information, which is information regarding the representative property, if a command to display the image is input.

The foregoing and/or other features and utilities of the present general inventive concept may also be achieved by providing a computer-readable medium containing codes to perform a method of displaying an image, the method including extracting from a storage a representative property based on at least one property which is preset for an image to be displayed on a display unit, and displaying information regarding the representative property and then the image to be displayed.

### BRIEF DESCRIPTION OF THE DRAWINGS

These and/or other features and utilities of the present general inventive will become apparent and more readily appreciated from the following description of the embodiments, taken in conjunction with the accompanying drawings of which:

FIG. 1 is a schematic diagram illustrating a configuration of a digital camcorder according to an exemplary embodiment of the present general inventive concept;

FIGS. 2A and 2B illustrate an example that images and representative property information are displayed;

FIG. 3 illustrates a method of detecting a representative property; and

FIG. 4 is a flow chart illustrating an image display method according to an exemplary embodiment of the present general inventive concept.

### DETAILED DESCRIPTION OF THE EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

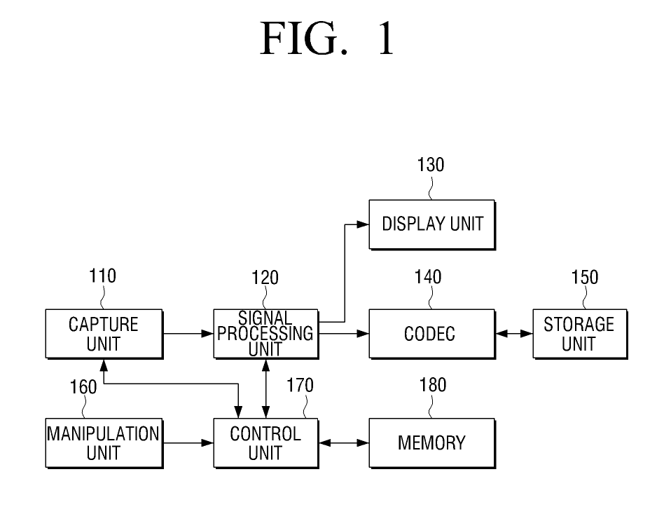

FIG. 1 is a schematic diagram illustrating a configuration of a digital camcorder according to an exemplary embodiment of the present general inventive concept. A digital camcorder is a type of image capture apparatus, stores an image generated by capture of the image, and displays the image.

Referring to FIG. 1, the digital camcorder may include a capture unit 110, a signal processing unit 120, a display unit 130, a codec 140, a storage unit 150, a manipulation unit 160, a control unit 170, and a memory 180.

The capture unit 110 converts an image of a captured object (subject), which is incident through a lens and is imaged on an optical surface, into an image signal. The signal processing unit 120 processes the image signal. The codec 140 generates an image file by compressing the image signal processed by the signal processing unit 120. The storage unit 150 stores the image file in a recording medium.

If the storage unit 150 reads the image file from the recording medium and transmits the image file to the codec 140, the codec 140 releases compression of the image file and generates an image signal.

The display unit 130 displays an image of an image signal generated by the capture unit 110 and processed by the signal processing unit 120. In addition, the display unit 130 displays an image of an image signal read by the storage unit 150 and decompressed by the codec 140.

The memory unit 180 stores a program processed by the control unit 170 and data needed to process this program. The manipulation unit 160 receives a user command, and includes physical buttons provided on a case of the digital camcorder.

The control unit 170 controls the capture unit 110, the signal processing unit 120, the codec 140, and the storage unit 150 so as to conduct a user command input through the manipulation unit 160.

In particular, the control unit 170 performs a series of procedures needed to display image files stored in the storage unit 150 on the display unit 130. More specifically, if a user inputs a command to output an image, the control unit 170 extracts a representative property based on at least one property which is preset for the image, displays information regarding the representative property (referred to hereinbelow as “representative property information”) prior to displaying the image, and automatically displays the image without a separate user command after displaying the representative property information.

The digital camcorder provides the user with the representative property information of the image for a period of time when the image is being decoded and displayed on the display unit 130, so the user can predict the image.

The digital camcorder provides the user with the representative property information of the image for a period of time when the image is decoded and displayed on the display unit 130, so the user can watch images in a row, thereby enabling continuity of display.

Here, the image indicates an image which the user actually wishes to view, and the representative property information indicates information regarding a property which is designated as a representative property from among at least one property regarding the image.

The property may be event information, tag information, name information, or capture date information of the image, and the representative property may be a property which is designated as the highest distinction between the image and other images from among these properties.

The representative property information may be an image which is designated as the highest expression of the representative property from among stored images. The representative property information may be designated by the user or may be automatically designated from among the stored images according to preset priority.

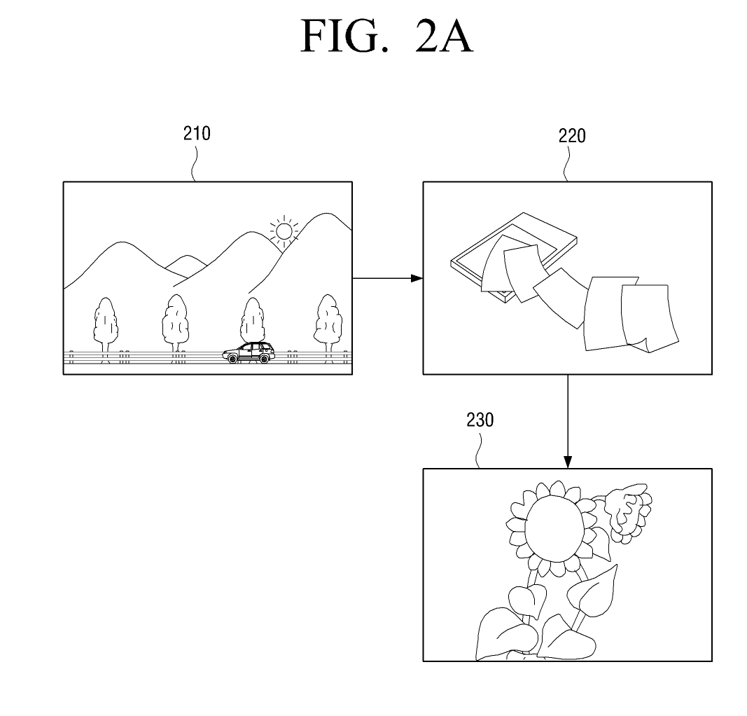

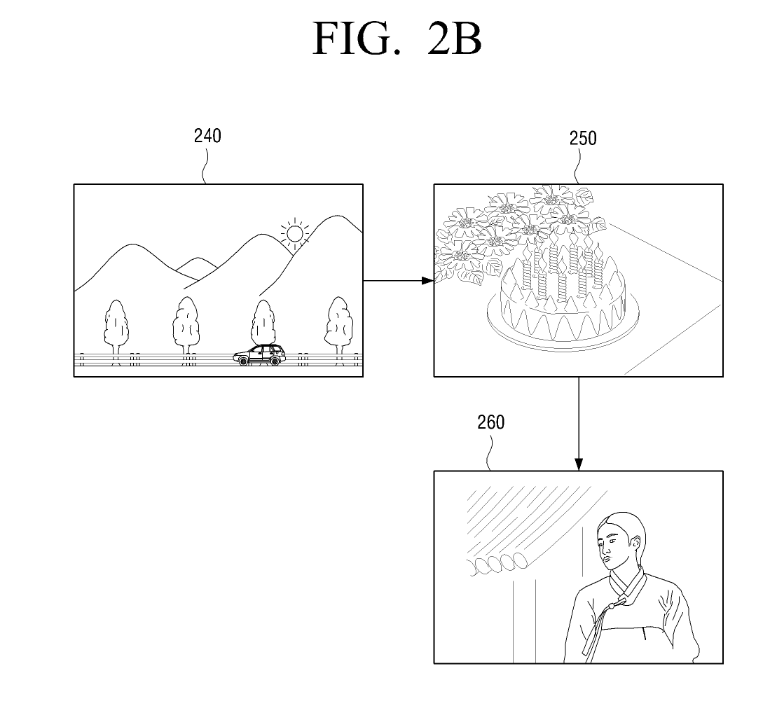

More detailed description of the representative property is given below with reference to FIGS. 2A and 2B.

FIGS. 2A and 2B illustrate an example in which images and representative property information are displayed.

Referring to FIG. 2A, if the user inputs a command to display an image 230 while another image 210 is being displayed, the digital camcorder decodes the image 230 and displays representative property information 220 before the image 230 can be displayed.

The representative property information 220 may be image information, and may be text information or audio information other than image information.

The representative property information 220 is information detected based on at least one property of the image 230. That is, the digital camcorder detects a property, which is the most suitable for representing the image 230 and the most representative, from among the properties of the image 230 as a representative property, and displays the detected representative property information 220 prior to displaying the image 230 so that the representative property information 220 can imply the image 230 or the characteristic of the image 230.

In FIG. 2A, a property that so much time has passed since the capture date of the image 230 is detected as a representative property of the image 230, and in order to show the property that so much time has passed, an image showing that time moves from today to the capture date using a turning calendar is selected and displayed as representative property information 220.

Accordingly, the user watches the representative property information 220, and thus can intuitively recognize that the capture date of the image 230 to be displayed precedes today by so much.

In the same manner, referring to FIG. 2B, if the user inputs a command to display an image 260 while another image 240 is being displayed, the digital camcorder decodes the image 260 and displays representative property information 250 before the image 260 can be displayed.

In FIG. 2B, event information “birthday” which has been stored together with the image 260 is detected as a representative property of the image 260, and in order to represent the event, an image showing a birthday cake is selected and displayed as representative property information 250.

Accordingly, the user watches the representative property information 250 and thus can intuitively recognize that the image 260 to be displayed relates to birthday.

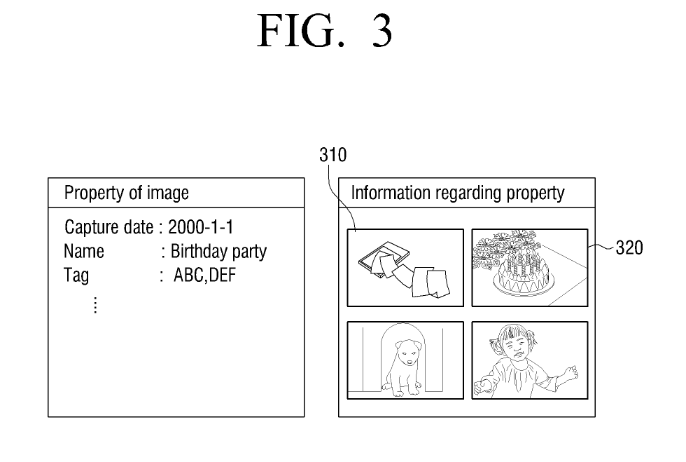

A method of detecting a representative property from among at least one property is described with reference to FIG. 3, which illustrates a method of detecting a representative property.

If the user captures an image using the digital camcorder, information regarding a capture date, name, or tag of the image may be stored together with the image. In general, digital camcorders automatically store a capture date of an image without the user's input, and store a name or tag of an image as a result of the user's input.

Accordingly, referring to FIG. 3, properties of the image include a property regarding capture date “Jan. 1, 2000” of the image, a property regarding name “birthday party” of the image, and a property regarding tag “ABC, DEF” of the image.

If the user inputs a command to display the image, the digital camcorder detects a representative property from among the properties, and designates information regarding the detected representative property. The representative property information may be designated by the user or may be automatically designated from among diverse information according to preset priority.

If the representative property information is set to be designated by the user, the representative property information designated by the user is displayed. For example, it is assumed that the user designates information 310 showing time elapsed as the representative property information which is matched with an image. If a command to display the image is input, the information 310 showing time elapsed is displayed as the representative property information of the image always before the image is displayed.

Matching the representative property information with the captured image may be performed after a command to display the image is input, or may be performed directly after the image is captured and stored without receiving a command to display.

In the same manner, the representative property information may be automatically designated from among diverse information according to preset priority.

The representative property itself as well as the representative property information may be determined by the user or may be automatically determined from among diverse properties according to preset priority.

For example, if the representative property is set to be automatically determined according to preset priority, the digital camcorder selectively displays the representative property from among the properties of the image according to priority. For example, it is assumed that priority of properties is set in the following order:

\textcircled{1} capture date when difference between the capture date and today is 5 years or more>\textcircled{2} name>\textcircled{3} capture date>\textcircled{4} tag

In this case, if today is after Jan. 1, 2005, the capture date is determined and detected as a representative property, and if today is before Jan. 1, 2005, the name “birthday party” is determined and detected as a representative property.

As described above, if the user inputs a command to display an image, representative property information is firstly displayed before the image is decoded and displayed. If the representative property information is a movie, a point of time to display the image may be after the representative property information is completely displayed or when the image is completely decoded and can be displayed.

In addition, when the representative property information is a movie, if the image cannot be displayed even after the representative property information is completely displayed, the representative property information is displayed again, or another property information may be displayed.

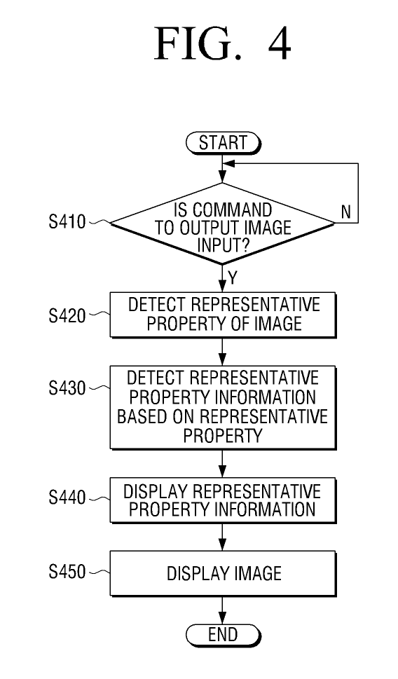

FIG. 4 is a flow chart illustrating an image display method according to an exemplary embodiment of the present general inventive concept.

In operation S410, the digital camcorder determines if the user inputs a command to output an image.

In operation S410-Y, if the digital camcorder determines that the user inputs a command to output an image, in operation S420 the digital camcorder detects a representative property from among at least one property of the image, and in operation S430 the digital camcorder detects representative property information based on the representative property.

In operation S440, the digital camcorder firstly displays the representative property information so that the user can predict a characteristic of the image, and in operation 450 if the representative property information is completely displayed or if the image can be displayed, in operation S450 the digital camcorder displays the image.

In the exemplary embodiments of the present general inventive concept, a digital camcorder is described as an example of a display apparatus, but this is merely an example for convenience of description, and other forms of a display apparatus apply. In other words, the technical ideas of the present general inventive concept can be applied to any display apparatuses capable of displaying images through compression and decompression such as portable media players (PMPs).

The exemplary embodiments of the present general inventive concept are described based on an apparatus to output an image. The technical idea of the present general inventive concept can be applied to an apparatus to output audio by compressing and depressing the audio such as MPEG-1 Audio Layer 3 (MP3).

In the exemplary embodiments of the present general inventive concept, an image which is captured by the user is expressed with an image and an image which is not captured by the user but is pre-stored in the digital camcorder is expressed with a representative property information, but this is merely an exemplary embodiment of the present general inventive concept. A representative property information may be an image captured by the user, and an image may be an image which is pre-stored in the digital camcorder.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As can be appreciated from the above description, images are displayed in a row so that the user does not need to wait while an image is being decoded, and information regarding a property of the image to be displayed is previously provided the user, so the user can effectively watch the image.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image display method, comprising:
determining a representative property from among at least one property of an image; and
displaying the image together with representative property information, which is information regarding the representative property, if a command to display the image is input.

2. The image display method according to claim 1, wherein the displaying of the image comprises:
decoding the image if the command to display the image is input;
in a first display operation, displaying the representative property information before the image is decoded and can be displayed; and
in a second display operation, displaying the image.

3. The image display method according to claim 2, wherein the second display operation comprises:
stopping displaying the representative property information and displaying the image if it is determined that the image is decoded and can be displayed.

4. The image display method according to claim 2, wherein the first display operation comprises:
displaying information regarding another property from among the at least one property of the image if the representative property information is completely displayed before the image is decoded and can be displayed.

5. The image display method according to claim 1, wherein the displaying of the image comprises:
automatically displaying the image even though a separate command is not input after displaying the representative property information.

6. The image display method according to claim 1, wherein if the representative property is a capture date, the representative property information is image information indicating that time moves from today to the capture date.

7. The image display method according to claim 1, wherein if the representative property is event information regarding an anniversary, the representative property information is image information indicating the anniversary.

8. An image matching method, comprising:
determining a representative property from among at least one property of a captured image; and
matching representative property information, which is information regarding the representative property, with the captured image.

9. The image matching method according to claim 8, further comprising:
displaying the captured image together with the representative property information if a command to display the captured image is input.

10. The image matching method according to claim 9, wherein the displaying of the captured image comprises:
alternately displaying each representative property information and each image if a command to display a plurality of images is input.

11. The image matching method according to claim 8, wherein the property includes at least one of event information, tag information, name information, capture date information of the captured image, and
the representative property is a property which is designated as the highest distinction between the captured image and other images from among the at least one property.

12. The image matching method according to claim 8, wherein the representative property information is an image which is designated as the biggest expression of the representative property from among stored images.

13. The image matching method according to claim 12, wherein the representative property information may be designated by a user or may be automatically designated from among the stored images according to preset priority.

14. A display apparatus, comprising:
a display unit to display an image; and
a control unit to determine a representative property from among at least one property of the image, and display the image together with representative property information, which is information regarding the representative property, if a command to display the image is input.

15. The display apparatus according to claim 14, further comprising:
a decoding unit to decode the image,
wherein the control unit displays the representative property information before the image is decoded and can be displayed, and subsequently displays the image.

16. The display apparatus according to claim 14, wherein the control unit automatically displays the image even though a separate command is not input after the representative property information is displayed.

17. The display apparatus according to claim 14, wherein the control unit alternately displays each representative property information and each image if a command to display a plurality of images is input.

18. The display apparatus according to claim 14, wherein the property includes at least one of event information, tag information, name information, capture date information of the image, and
the representative property is a property which is designated as the highest distinction between the image and other images from among the at least one property.

19. The display apparatus according to claim 14, wherein the representative property information is an image which is designated as the biggest expression of the representative property from among stored images.

20. The display apparatus according to claim 19, wherein the representative property information may be designated by a user or may be automatically designated from among the stored images according to preset priority.

21. A method of displaying an image, comprising:
extracting from a storage a representative property based on at least one property which is preset for an image to be displayed on a display unit; and
displaying information regarding the representative property and then the image to be displayed.

22. The method of claim 21, wherein the displaying information regarding the representative property and then the image to be displayed is performed automatically in sequence.

23. The method of claim 21, wherein the extracting is performed in response to a user input.

24. The method of claim 23, wherein the representative property information of the image to be displayed is provided for a period of time while the image is being decoded and displayed on the display unit.

25. The method of claim 21, wherein the representative property information of the image to be displayed is one of event information, tag information, name information and capture information of the image.

26. A computer-readable medium containing codes to perform a method of image display, the method comprising:
determining a representative property from among at least one property of an image; and
displaying the image together with representative property information, which is information regarding the representative property, if a command to display the image is input.

27. A computer-readable medium containing codes to perform a method of displaying an image, the method comprising:
extracting from a storage a representative property based on at least one property which is preset for an image to be displayed on a display unit; and
displaying information regarding the representative property and then the image to be displayed.
